(19) United States
(12) Patent Application Publication
(10) Pub. No.: US 2014/0162128 A1
(43) Pub. Date: Jun. 12, 2014

(54) POSITIVE ACTIVE MATERIAL FOR RECHARGEABLE LITHIUM BATTERY, AND POSITIVE ELECTRODE FOR RECHARGEABLE LITHIUM BATTERY AND RECHARGEABLE LITHIUM BATTERY INCLUDING SAME

(71) Applicant: Samsung SDI Co., Ltd., Yongin-si (KR)

(72) Inventors: Masatsugu NAKANO, Osaka (JP); Yuki TAKEI, Osaka (JP)

(73) Assignee: Samsung SDI Co., Ltd., Yongin-si (KR)

(21) Appl. No.: 14/102,288

(22) Filed: Dec. 10, 2013

(30) Foreign Application Priority Data
Dec. 12, 2012 (JP) 2012-271536
Sep. 26, 2013 (KR) 10-2013-0114614
Dec. 2, 2013 (JP) 2013-249671

(51) Int. Cl. H01M 4/505; H01M 4/131

(52) U.S. Cl. CPC H01M 4/505; H01M 4/131
USPC 429/224

(57) ABSTRACT

A positive active material for a rechargeable lithium battery is disclosed. The positive active material includes a lithium manganese oxide-based solid solution having a specific surface area of about 3 m2/g to about 12 m2/g and a crystallite diameter of about 40 nm to about 120 nm. In addition, a positive electrode for rechargeable lithium battery and rechargeable lithium battery including a positive active material is also disclosed.

### INCORPORATION BY REFERENCE TO ANY PRIORITY APPLICATIONS

Any and all priority claims identified in the Application Data Sheet, or any correction thereto, are hereby incorporated by reference under 37 CFR 1.57. For example, this application claims the benefit of Japanese Patent Application No. 2012-271536 filed in the Japanese Patent Office on Dec. 12, 2012, Japanese Patent Application No. 2013-249671 filed in the Japanese Patent Office on Dec. 2, 2013, and Korean Patent Application No. 10-2013-0114614 filed in the Korean Intellectual Property Office on Sep. 26, 2013, the disclosures of which are incorporated herein by reference in their entirety.

### BACKGROUND

1. Field

The disclosed technology relates to a positive active material for a rechargeable lithium battery, and a positive electrode for a rechargeable lithium battery and a rechargeable lithium battery including the same.

2. Description of the Related Technology

The lithium manganese oxide-based solid solution material has been actively researched as a positive active material for a rechargeable lithium battery. A battery containing lithium manganese oxide-based solid solution can have a high-capacity when charged at a high voltage.

However, the battery containing the lithium manganese oxide-based solid solution has a low limit in the cycle-life of the battery when repeatedly charged and discharged at a high voltage.

### SUMMARY OF CERTAIN INVENTIVE ASPECTS

One aspect of the disclosure relates to a positive active material for a rechargeable lithium battery suppressing deterioration of discharge capacity according to the repeated charge and discharge cycles and improving cycle-life characteristics.

Another aspect of the disclosure relates to a positive electrode for a rechargeable lithium battery including the positive active material.

Yet another aspect of the disclosure relates to a rechargeable lithium battery including the positive electrode.

One aspect of the disclosure relates to a positive active material for a rechargeable lithium battery including a lithium manganese oxide-based solid solution having a specific surface area of about 3 m²/g to about 12 m²/g and a crystallite diameter of about 40 nm to about 120 nm.

In some embodiments, the lithium manganese oxide-based solid solution may have a specific surface area of about 6 m²/g to about 12 m²/g.

In some embodiments, the lithium manganese oxide-based solid solution may have a crystallite diameter of about 40 nm to about 70 nm.

In some embodiments, the lithium manganese oxide-based solid solution may be represented by the following Chemical Formula 1.

xLi₂MnO₃.(1-x)LiMO₂ [Chemical Formula 1]

In the above Chemical Formula 1,

M is represented by the following Chemical Formula 2, and 0.2≦x≦0.5.

MnₐCo_{b}Ni_{c}M′_{d} [Chemical Formula 2]

In the above Chemical Formula 2,

M′ is a transition metal except for Mn, Co, and Ni,

0.2≦a≦0.5, 0.1≦b≦0.4, 0.2≦c≦0.5, 0≦d≦0.5, and a+b+c+d=1.

Another aspect of the disclosed technology relates to a positive electrode for a rechargeable lithium battery including the positive active material.

Yet another aspect of the disclosed technology relates to a rechargeable lithium battery including the positive electrode; a negative electrode; and an electrolyte solution.

Other embodiments are included in the following detailed description.

Another aspect of the disclosed technology relates to a rechargeable lithium battery that is suppressed from crack generation of a lithium manganese oxide-based solid solution and from deterioration of discharge capacity during the repeated charge and discharge cycles and having improved cycle-life characteristics.

### BRIEF DESCRIPTION OF THE DRAWINGS

FIG. 1 is a cross-sectional view showing the schematic structure of a rechargeable lithium battery.

FIG. 2 is a graph showing a relationship between a specific surface area of a lithium manganese oxide-based solid solution and a voltage drop.

FIG. 3 is a graph showing a relationship between a crystallite diameter of lithium manganese oxide-based solid solution and a voltage drop.

### DETAILED DESCRIPTION OF CERTAIN INVENTIVE EMBODIMENTS

Hereinafter, embodiments are described in detail. However, these embodiments are exemplary, and this disclosure is not limited thereto.

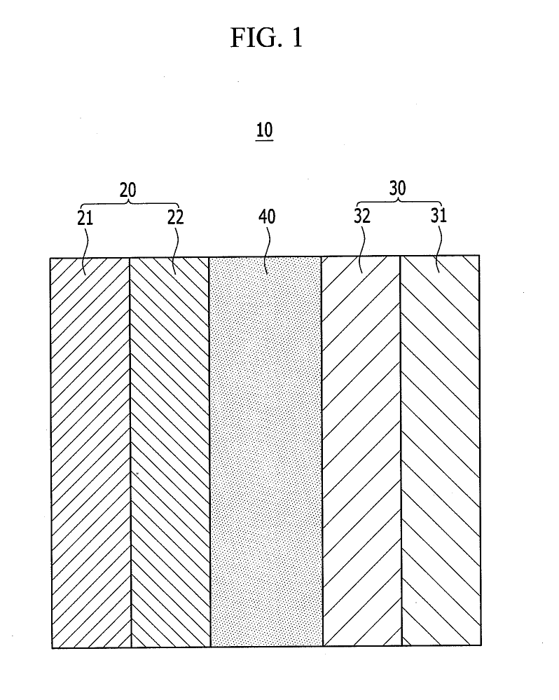

Hereinafter, one example of a rechargeable lithium battery is described referring to FIG. 1.

FIG. 1 is a cross-sectional view showing the schematic structure of a rechargeable lithium battery.

Referring to FIG. 1, a rechargeable lithium battery 10 includes a positive electrode 20, a negative electrode 30, and a separator layer 40 interposed between the positive electrode 20 and the negative electrode 30.

The rechargeable lithium battery may have a charge cut-off voltage (oxidation reduction potential) of, for example, about 4.5V to about 5.0V (vs. Li/Li⁺).

The rechargeable lithium battery has no particular limit about its shape and may have a shape such as a cylinder, a prism, a laminated type, a coin-type, and the like.

In some embodiments, the positive electrode 20 includes a current collector 21 and a positive active material layer 22 formed on the current collector 21.

The current collector may be, for example aluminum, and the like.

In some embodiments, the positive active material layer can include a positive active material and a conductive material, and additionally a binder.

In some embodiments, the positive active material may include a lithium manganese oxide-based solid solution.

The lithium manganese oxide-based solid solution may be a solid solution including Li₂MnO₃, and specifically may be represented by the following Chemical Formula 1.

xLi₂MnO₃.(1-x)LiMO₂ [Chemical Formula 1]

In the above Chemical Formula 1,

M is represented by the following Chemical Formula 2, and 0.2≦x≦0.5.

MnₐCo_{b}Ni_{c}M′_{d} [Chemical Formula 2]

In the above Chemical Formula 2,

M′ is a transition metal except for Mn, Co, and Ni, and may be Sc, Ti, V, Cr, Fe, Cu, Zn, Y, Zr, Nb, Mo, Tc, Ru, Rh, Pd, Ag, Cd, La, Hf, Ta, W, Re, Os, Ir, Pt, Au, Hg, Ac, Rf, Db, Sg, Bh, Hs, or a combination thereof,

0.2≦a≦0.5, 0.1≦b≦0.4, 0.2≦c≦0.5, 0≦d≦0.5 and a+b+c+d=1.

In one embodiment, M′ may be Sc, Ti, V, Cr, Fe, Cu, Zn, Y, Zr, Nb, Mo, Tc, Ru, Hf, Ta, W, Re, or a combination thereof.

In some embodiments, the rechargeable lithium battery using the lithium manganese oxide-based solid solution as a positive active material shows greater than or equal to about 200 mAh/g of high-capacity when charged at a high voltage of greater than or equal to about 4.5V. The lithium manganese oxide-based solid solution causes a phase change during charge and discharge, that is to say, from a layered crystal structure to a spinel-type crystal structure during charge and from a spinel-type crystal structure to a layered crystal structure during discharge in terms of the crystal structure, and this phase change may contribute to increase of discharge capacity.

In some embodiments, the phase change may not reversibly occur during charge and discharge at a high voltage as the charge and discharge cycle is repeated. In other words, a part of crystallites does not come back to the layered crystal structure from the spinel-type crystal structure during the discharge, and thus, the crystallite having the spinel-type crystal structure increases, as a charge and discharge cycle is repeated. Accordingly, the number of the crystallite contributing to the charge and discharge decreases and deteriorates cycle-life characteristics. In addition, as the number of the crystallite having the spinel-type crystal structure increases, the internal stress of the solid solution also increases, and this stress may cause a crack on the surface of the solid solution.

In some embodiments, the specific surface area and crystallite diameter of the lithium manganese oxide-based solid solution may be adjusted to avoid crack generation and to maintain high-capacity characteristics despite the repeated charge and discharge cycles when charged at a high voltage, that is, to bring about excellent battery cycle-life.

Specifically, the lithium manganese oxide-based solid solution may have a specific surface area of about 3 m²/g to about 12 m²/g, and more specifically about 6 m²/g to about 12 m²/g. When the lithium manganese oxide-based solid solution has a specific surface area within the range, each crystallite in the solid solution has excellent fluidity and is difficult to break and thus, may reversibly cause a phase change during the charge and discharge. Accordingly, when charged and discharged at a high voltage, the lithium manganese oxide-based solid solution may be suppressed from a forming crack on the surface and increase the battery cycle-life during the charge and discharge.

The specific surface area may be measured for example using a nitrogen adsorption method.

In addition, the lithium manganese oxide-based solid solution may have a crystallite diameter in the range of about 40 nm to about 120 nm, and specifically in the range of about 40 nm to about 70 nm. When the lithium manganese oxide-based solid solution has a crystallite diameter within the range, each crystallite in the solid solution has excellent fluidity and is difficult to break and thus, may reversibly cause a phase change during the charge and discharge. Accordingly, when charged and discharged at a high voltage, the lithium manganese oxide-based solid solution may be suppressed from forming a crack on the surface and increase the battery cycle-life.

The crystallite indicates a single crystal having a fine size, and thus, the lithium manganese oxide-based solid solution may be multi-crystal formed of these crystallites.

Specifically, the crystallite diameter may be defined by the following Equation 1.

D=(K*λ)/(β*cos θ) [Equation 1]

In the Equation 1,

D is a crystallite diameter,

K is a Scherrer constant, for example, 0.9,

β is a full width at half maximum (rad) of a peak around a diffraction angle by an X-ray diffraction (XRD) and the peak is a diffraction peak at a (003) plane of a crystallite, and

θ is a diffraction angle (rad).

Units of the β and θ are radian.

The specific surface area and the crystallite diameter may be controlled by adjusting an agitation speed, an agitation time, a firing temperature, a firing time, and the like during the manufacture of the lithium manganese oxide-based solid solution.

In some embodiments, the lithium manganese oxide-based solid solution may be prepared in a co-precipitation method and the like without a particular limit.

Specifically, a nickel source, a manganese source and a cobalt source are dissolved in ion exchanged water to prepare a mixed aqueous solution. The nickel source may be nickel sulfate hexa(6)hydrate, nickel acetate tetrahydrate, nickel chloride hexahydrate, nickel nitrate hexahydrate, or a comibination thereof, the manganese source may be manganese sulfate hepta(7)hydrate, manganese acetate tetrahydrate, manganese chloride tetrahydrate or a comibination thereof, and the cobalt source may be cobalt sulfate penta(5)hydrate, cobalt acetate tetrahydrate, or cobalt nitrate tetrahydrate or a combination thereof.

The nickel source, the manganese source, and the cobalt source may be used in an amount of 10 wt % to 25 wt % based on the total amount of the mixed aqueous solution. In addition, the nickel source, the manganese source, and the cobalt source are mixed at an appropriate ratio for obtaining a desired mole ratio of Ni, Co, and Mn. The mole ratio of the elements is determined according to composition of a lithium manganese oxide-based solid solution. For example, 0.4Li₂MnO₃-0.6Li (Mn_{1/3}Co_{1/3}Ni_{1/3})O₂ is prepared by using Mn:Co:Ni in a mole ratio of 60:20:20.

During the preparation of the mixed aqueous solution, a M′ source may be further added. The M′ source may be M-including sulfate, but it is not limited thereto. The exemplary of the M′ source may be titanium sulfate, vanadium sulfate.n hydrdate, iron sulfate heptahydrate, or a combination thereof.

On the other hand, the ion exchanged water in a predetermined amount is put in a reaction vessel and maintained at 25° C. to 60° C. to prepare a reaction vessel-aqueous solution.

Subsequently, a NaOH aqueous solution (including 40 wt % of NaOH based on the total weight of the NaOH aqueous solution) is added to the ion exchange water in a dropwise fashion to adjust the pH of the reaction vessel-aqueous solution into 11.3 to 12.3. Then, the ion exchanged water was bubbled with inert gas such as nitrogen and the like to remove oxygen dissolved therein.

The reaction vessel-aqueous solution was agitated and maintained at 25° C. to 60° C., and the mixed aqueous solution was added thereto in a dropwise fashion. The addition has no particular limit in a speed but may be, for example, about 1 ml/min to 10 ml/min.

A NaOH aqueous solution (including 40 wt % of NaOH based on the total weight of the NaOH aqueous solution) and a NH₃ aqueous solution (10 wt % of NH₃ based on the total weight of the NH₃ aqueous solution) are additionally added to the resulting reaction vessel-aqueous solution, and the mixture is agitated and maintained at pH of 11.3 to 12.3 to coprecipitate hydroxide of each metal element.

Herein, the agitation may be performed at a predetermined rate and time. For example, the agitation rate may be in the range of about 1 m/s to about 10 m/s, and the agitation time may be in the range of about 5 hours. When the agitation rate and time are performed within the range, a specific surface area and a crystallite diameter within the range according to one embodiment may be obtained.

Subsequently, the separation of solid and liquid is performed. For example, the co-precipitated hydroxide is taken from the resulting reaction vessel-aqueous solution by using suction filtration and washed with ion exchanged water.

Subsequently, the co-precipitated hydroxide is vacuum-dried. The drying may be performed for example at about 80° C. to 150° C., for example, for about 5 hours to 12 hours. After the drying, the co-precipitated hydroxide is ground for several minutes with a mortar to obtain dried powder. The dried powder is mixed with lithium carbonate to obtain mixed powder. Herein, a mole ratio between Li and M(Ni+Mn+Co) is determined by the composition of a solid solution. For example, 0.4Li₂MnO₃-0.6Li(Mn_{1/3}Co_{1/3}Ni_{1/3})O₂ is prepared by mixing in 1.4:1 of a mole ratio between Li and M.

Subsequently, the mixed powder is fired for a predetermined time at a predetermined temperature. Accordingly, the lithium manganese oxide-based solid solution may be prepared. Herein, the firing may be performed for about 4 hours to about 24 hours at a temperature ranging from about 710° C. to about 980° C. and specifically, about 720° C. to about 930° C.

In some embodiments, the amount of the lithium manganese oxide-based solid solution is not particularly limited, and may be applied in an amount to form a positive active material layer for a rechargeable lithium battery.

The conductive material may include, for example, carbon black such as ketjen black, acetylene black, and the like, natural graphite, artificial graphite, and the like but has no particular limit, as far as any material increases conductivity of a positive electrode.

In some embodiments, the amount of the conductive material is not particularly limited, and may be used in an amount used in a positive active material layer of a rechargeable lithium battery.

The binder may include, for example, polyvinylidene fluoride, an ethylene-propylene-diene terpolymer, a styrene-butadiene rubber, an acrylonitrile-butadiene rubber, a fluoro rubber, polyvinyl acetate, polymethylmethacrylate, polyethylene, nitrocellulose, and the like, but has no particular limit as far as any material binds the positive active material and the conductive material on the current collector.

In some embodiments, the amount of the binder is not particularly limited, but may be in an applicable amount to a positive active material layer of a rechargeable lithium battery.

The positive active material layer may be formed by, for example, dispersing the positive active material, the conductive material, and the binder in an organic solvent such as N-methyl-2-pyrrolidone, and the like to form slurry, and coating the slurry on the current collector followed by drying the same.

The coating method has no particular limit but may include, for example, a knife coating, a gravure coating, and the like.

Subsequently, the positive active material layer is compressed using a presser to manufacture a positive electrode having a desired thickness. Herein, the thickness of the positive active material layer is not particularly limited.

In some embodiments, the negative electrode 30 includes a current collector 31 and a negative active material layer 32 formed on the current collector 31.

The current collector 31 may be, for example copper, nickel, and the like.

The negative active material layer may be any usable negative active material layer of a rechargeable lithium battery. For example, the negative active material layer may include a negative active material, and additionally a binder.

The negative active material may include, for example, artificial graphite, natural graphite, a mixture of artificial graphite and natural graphite, natural graphite coated with artificial graphite, and the like; a mixture of a particulate of silicon, tin or oxides thereof and the graphite; a silicon or tin particulate; a silicon- or tin-containing alloy; a titanium oxide-compound such as Li₄Ti₅O₁₂, and the like. The silicon oxide may be represented by SiOₓ (0<x≦2). In addition, metal lithium, and the like may also be used.

The binder may be the same as the binder of the positive active material layer.

The mixing weight ratio of the negative active material and the binder is not particularly limited.

The negative electrode may be manufactured according to the same method as the positive electrode.

Specifically, the negative active material and the binder are mixed at a predetermined ratio and dispersed in an organic solvent such as N-methyl-2-pyrrolidone, and the like to form slurry. Then, the slurry is coated on a current collector and dried to form a negative active material layer. Subsequently, the negative active material layer is compressed using a presser to manufacture a negative electrode having a desired thickness. Herein, the thickness of the negative active material layer is not particularly limited.

When the negative active material layer is metal lithium, the current collector may be a metal lithium foil.

The separator 40 is not particularly limited, and may be any separator that is usable for a rechargeable lithium battery. Specifically, a porous film or a non-woven fabric having excellent high-rate discharge performance may be used singularly or as a mixture.

In some embodiments, the material of the separator may include, for example, a polyolefin-based resin such as polyethylene, polypropylene and the like; a polyester-based resin such as polyethylene terephthalate, polybutylene terephthalate, and the like; a fluorinated resin such as polyvinylidene fluoride, a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, and the like.

The porosity of the separator is not particularly limited.

The separator may be impregnated with an electrolyte.

The electrolyte may not be particularly limited and may be anything usable for a rechargeable lithium battery. Specifically, the electrolyte includes an electrolytic salt dissolved in a non-aqueous solvent.

The non-aqueous solvent may be, for example, cyclic carbonates such as propylene carbonate, ethylene carbonate, butylene carbonate, chloroethylene carbonate, vinylene carbonate, and the like; cyclic esters such as γ-butyrolactone, γ-valero lactone, and the like; linear carbonates such as dimethyl carbonate, diethyl carbonate, ethylmethyl carbonate, and the like; linear esters such as methyl formate, methyl acetate, methyl butyrate, and the like; tetrahydrofuran or a derivative thereof; ethers such as 1,3-dioxane, 1,4-dioxane, 1,2-dimethoxyethane, 1,4-dibutoxyethane, methyl diglyme, and the like; nitriles such as acetonitrile, benzonitrile and the like; dioxolane or a derivative thereof; ethylene sulfide, sulfolane, sultone or a derivative thereof, and the like. These may be used singularly or in a mixture of two or more.

The electrolytic salt may be, for example, an inorganic ionic salt such as LiClO₄, LiBF₄, LiAsF₆, LiPF₆, LiSCN, LiBr, LiI, Li₂SO₄, Li₂B₁₀Cl₁₀, NaClO₄, NaI, NaSCN, NaBr, KClO₄, KSCN, and the like; an organic ionic salt such as LiCF₃SO₃, LiN(CF₃SO₂)₂, LiN(C₂F₅SO₂)₂, LiN(CF₃SO₂)(C₄F₉SO₂), LiC(CF₃SO₂)₃, LiC(C₂F₅SO₂)₃, (CH₃)₄NBF₄, (CH₃)₄NBr, (C₂H₅)₄NClO₄, (C₂H₅)₄NI, (C₃H₇)₄NBr, (n-C₄H₉)₄NClO₄, (n-C₄H₉)₄NI, (C₂H₅)₄N-maleate, (C₂H₅)₄N-benzoate, (C₂H₅)₄N-phthalate, lithium stearyl sulfonate, lithium octyl sulfonate, lithium dodecyl benzene sulfonate, and the like, and these may be used singularly or in a mixture of two or more.

The concentration of the electrolytic salt is not particularly limited, but may be specifically about 0.5 mol/L to about 2.0 mol/L.

In some embodiments, the rechargeable lithium battery may be manufactured as follows.

The separator 40 is disposed between the positive electrode 20 and the negative electrode 30 to manufacture an electrode assembly. Subsequently, the electrode assembly is processed to have a desired shape, for example, a cylinder, a prism, a laminated type, a coin type, and the like and then, inserted into the container. Then, the above electrolyte is injected into the container, so that each pore of the separator may be impregnated with the electrolyte solution.

Hereinafter, the embodiments are illustrated in more detail with reference to examples. However, these examples are exemplary, and the present disclosure is not limited thereto.

Furthermore, what is not described in this disclosure may be sufficiently understood by those who have knowledge in this field and will not be illustrated here.

### EXAMPLES 1 TO 5 AND COMPARATIVE EXAMPLES 1 AND 2

### Preparation of Lithium Manganese Oxide-Based Solid Solution

The mixed aqueous solution was prepared by dissolving nickel sulfate hexahydrate, manganese sulfate heptahydrate, and cobalt sulfate pentahydrate in ion exchanged water. Herein, the total amount of the nickel sulfate hexahydrate, the manganese sulfate heptahydrate, and the cobalt sulfate pentahydrate was included in an amount of 20 wt % based on total amount of the mixed aqueous solution. In addition, the nickel sulfate hexahydrate, manganese sulfate heptahydrate, and cobalt sulfate pentahydrate were mixed so that an element mole ratio of Mn:Co:Ni might be 60:20:20.

On the other hand, 500 ml of ion exchanged water was put in a reaction vessel and maintained at 50° C. A NaOH aqueous solution (including 40 wt % of NaOH based on the total weight of the NaOH aqueous solution) was added to the ion exchanged water in a dropwise fashion to adjust pH of the aqueous solution in the reaction vessel to be 11.5, to prepare a reaction vessel-aqueous solution. Subsequently, the ion exchanged water was bubbled with nitrogen gas to remove oxygen dissolved therein.

The reaction vessel-aqueous solution was agitated and maintained at 50° C., and the mixed aqueous solution was added thereto at a rate of 3 ml/min.

In addition, the NaOH aqueous solution (including 40 wt % of NaOH based on the total weight of the NaOH aqueous solution) and a NH₃ aqueous solution (including 10 wt % of NH₃ based on the total weight of the NH₃ aqueous solution) were additionally added thereto and agitated to maintain a pH of the resulting reaction vessel-aqueous solution at 11.5, to prepare a reaction layer aqueous solution. Herein, the agitation was performed at a rate of 5 m/s for 10 hours. According to the process, hydroxide of each metal element was co-precipitated.

Subsequently, the co-precipitated hydroxides were taken from the reaction layer aqueous solution by suction filtration and washed with ion exchanged water. Then, the co-precipitated hydroxide was vacuum-dried. The vacuum-drying was performed at 100° C. for 10 hours.

Subsequently, the dried co-precipitation hydroxide was ground with a mortar and dried, obtaining a dried powder. The dried powder was mixed with lithium carbonate, obtaining mixed powder. Herein, Li and M (Ni+Mn+Co) were mixed in a mole ratio of 1.4:1.

Subsequently, the mixed powder was divided into 7 samples, and each sample was fired. Herein, firing of all the samples were performed for 6 hours by changing the firing temperature in a range of 700 to 1000° C. In other words, each sample was respectively fired at a different temperature as shown in the following Table 1, preparing lithium manganese oxide-based solid solutions according to Examples 1 to 5 and Comparative Examples 1 and 2.

TABLE 1

| | | | | | | Compar- | |
|---|---|---|---|---|---|---|---|
| | | | | | | ative | |
| | Example | | | | | Example | |
| | 1 | 2 | 3 | 4 | 5 | 1 | 2 |
| Firing temperature | 725 | 750 | 800 | 850 | 900 | 700 | 1000 |
| (° C.) | | | | | | | |

### Manufacture of Rechargeable Lithium Battery Cell

Each lithium manganese oxide-based solid solution was mixed with acetylene black and polyvinylidene fluoride in a weight ratio of 80:13:7. This mixture was dispersed into N-methyl-2-pyrrolidone to prepare a slurry. The slurry was coated and dried on an aluminum foil as a current collector to form a positive active material layer, and the positive active material layer was compressed to be 50 μm thick to manufacture the positive electrode.

The negative electrode was manufactured by mounting a metal lithium foil on a copper foil as a current collector.

As for a separator, a 12 μm-thick porous polyethylene film was used and disposed between the positive and negative electrodes, manufacturing an electrode assembly.

Subsequently, the electrode assembly was manufactured into a size of a CR2032 coin half-cell and inserted in a CR2032 coin half-cell container.

An electrolyte solution was prepared by mixing ethylene carbonate and dimethyl carbonate in a volume ratio of 3:7 to prepare a non-aqueous solvent and dissolving lithium hexafluorophosphate in a concentration of 1.00 mol/L.

The electrolyte solution was injected into the coin half-cell container and thus, impregnated into the separator to make the rechargeable lithium battery cell.

### Evaluation 1

### Measurement of Specific Surface Area and Crystallite Diameter of Lithium Manganese Oxide-Based Solid Solution

The specific surface areas of the lithium manganese oxide-based solid solutions according to Examples 1 to 5 and Comparative Examples 1 and 2 were measured using a nitrogen adsorption method, and the results are provided in the following Table 2.

In addition, the crystallite diameter of the lithium manganese oxide-based solid solutions according to Examples 1 to 5 and Comparative Examples 1 and 2 were measured, and the results are provided in the following Table 2.

When an X-ray diffraction test was performed on the lithium manganese oxide-based solid solutions, a peak around a diffraction angle of 18° was observed. The crystallite diameter was obtained by using a diffraction angle and a full width at half maximum of the peak and also, the following equation 1.

D=(K*λ)/(β*cos θ) [Equation 1]

In the Equation 1 above, D is a crystallite diameter, K is 0.9, β is a full width at half maximum (rad) of a peak around a diffraction angle by an X-ray diffraction (XRD) and the peak is a diffraction peak at a (003) plane of a crystallite, and θ is 18/360*2π (rad).

TABLE 2

| | Crystallite | Specific surface |
|---|---|---|
| | diameter (nm) | area (m²/g) |
| Example 1 | 40 | 12 |
| Example 2 | 50 | 8 |
| Example 3 | 70 | 6 |
| Example 4 | 90 | 5 |
| Example 5 | 120 | 3 |
| Comparative Example 1 | 30 | 15 |
| Comparative Example 2 | 150 | 2 |

### Evaluation 2

### Charge and Discharge Characteristics of Rechargeable Lithium Battery Cell

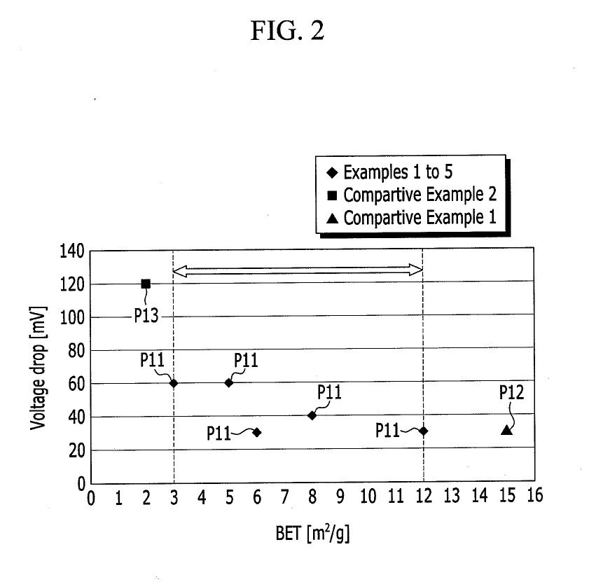

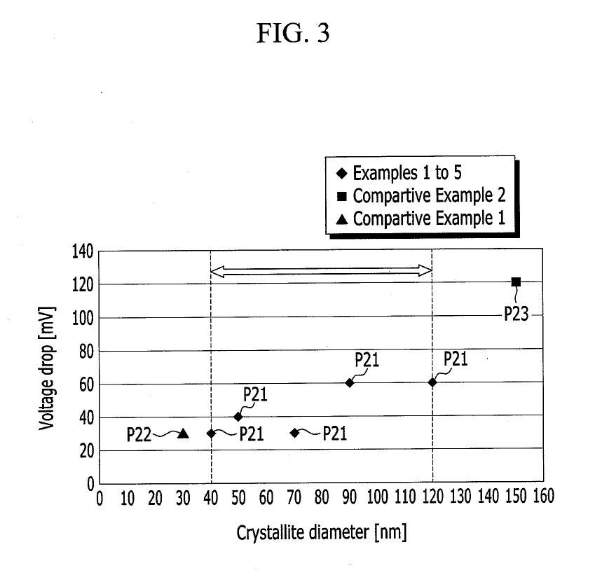

The charge and discharge evaluation of the rechargeable lithium battery cells according to Examples 1 to 5 and Comparative Examples 1 and 2 was performed as in the following Table 3, and the results are provided in the following Table 4 and FIGS. 2 and 3.

TABLE 3

| Cycle number | Charge rate | Discharge rate | Cut-off voltage (V) |
|---|---|---|---|
| 1 | 0.1 C CC-CV | 0.1 C CC | 4.8-2.0 |
| 2 | 0.2 C CC-CV | 0.2 C CC | 4.7-2.5 |
| 3-49 | 1 C CC-CV | 1 C CC | 4.7-2.5 |
| 50 | 0.2 C CC-CV | 0.2 C CC | 4.7-2.5 |

In Table 3, the CC-CV indicates a constant current and constant voltage charge, and the CC indicates a constant current discharge. The cut-off voltage indicates a voltage when the charge and discharge end. For example, the charge was performed up to a voltage of 4.8V of the rechargeable lithium battery cells, and the discharge was performed up to a voltage of 2.0V of the rechargeable lithium battery cells in the 1st cycle.

In the following Table 4, the capacity retention (%) was obtained as a percentage of discharge capacity at the 50th cycle relative to discharge capacity at the 2nd cycle. In addition, the average discharge voltage (V) was obtained by measuring a voltage during the discharge at a plurality of times and calculating an arithmetic mean. In addition, a voltage drop was a difference between average discharge voltage at the 2nd cycle and average discharge voltage at the 50 cycle. The smaller the difference was, the smaller change a discharge curved line had.

TABLE 4

| | | Average discharge | | |
|---|---|---|---|---|
| | Capacity | voltage (V) | | Voltage |
| | retention | 2nd | 50th | drop |
| | (%) | cycle | cycle | (mV) |
| Example 1 | 95 | 3.60 | 3.57 | 30 |
| Example 2 | 95 | 3.60 | 3.56 | 40 |
| Example 3 | 95 | 3.60 | 3.57 | 30 |
| Example 4 | 95 | 3.62 | 3.56 | 60 |
| Example 5 | 95 | 3.62 | 3.56 | 60 |
| Comparative Example 1 | 80 | 3.55 | 3.52 | 30 |
| Comparative Example 2 | 92 | 3.65 | 3.53 | 120 |

FIG. 2 is a graph showing the relationship between a specific surface area of a lithium manganese oxide-based solid solution and a voltage drop.

In FIG. 2, five points, P11, indicate measurement values of Examples 1 to 5, points P12 and P13 respectively indicate measurement values of Comparative Examples 1 and 2.

FIG. 3 is a graph showing the relationship between a crystallite diameter of lithium manganese oxide-based solid solution and a voltage drop.

In FIG. 3, five points, P21, indicate measurement values of Examples 1 to 5, and points, P22 and P23 respectively indicate measurement values of Comparative Examples 1 and 2.

Referring to Table 4 and FIGS. 2 and 3, Examples 1 to 5 showed a suppressed change in a discharge curved line and simultaneously, excellent battery cycle-life characteristics. On the other hand, the Comparative Example 1 showed a suppressed change in a discharge curved line but deteriorated battery cycle-life characteristics. In addition, Comparative Example 2 showed a large change in a discharge curved line.

In addition, when the lithium manganese oxide-based solid solutions after the charge and discharge evaluation were examined using an electron microscope, Examples 1 to 5 showed no cracks, but Comparative Examples 1 and 2 showed cracks.

Accordingly, when the lithium manganese oxide-based solid solutions had a specific surface area and a crystallite diameter within the range, generation of a crack and changes in a discharge curved line were suppressed, and simultaneously, battery cycle-life has been increased.

While this disclosure has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A positive active material for a rechargeable lithium battery comprising a lithium manganese oxide-based solid solution having a specific surface area in the range of about 3 m²/g to about 12 m²/g and a crystallite diameter in the range of about 40 nm to about 120 nm.

2. The positive active material of claim 1, wherein the lithium manganese oxide-based solid solution has a specific surface area in the range of about 6 m²/g to about 12 m²/g.

3. The positive active material of claim 1, wherein the lithium manganese oxide-based solid solution has a crystallite diameter in the range of about 40 nm to about 70 nm.

4. The positive active material of claim 1, wherein the lithium manganese oxide-based solid solution is represented by the following Chemical Formula 1:
xLi₂MnO₃.(1-x)LiMO₂ [Chemical Formula 1]
wherein,
M is represented by the following Chemical Formula 2, and 0.2≦x≦0.5,
MnₐCo_{b}Ni_{c}M′_{d} [Chemical Formula 2]
wherein,
M′ is a transition metal except for Mn, Co, and Ni,
0.2≦a≦0.5, 0.1≦b≦0.4, 0.2≦c≦0.5, 0≦d≦0.5 and a+b+c+d=1.

5. A positive electrode for a rechargeable lithium battery comprising the positive active material according to claim 1.

6. A rechargeable lithium battery, comprising
the positive electrode according to claim 5;
a negative electrode; and
an electrolyte.
